(19) United States
(12) Patent Application Publication
(10) Pub. No.: US 2004/0018853 A1
(43) Pub. Date: Jan. 29, 2004

(54) Alternative radio system monitoring

(75) Inventor: Jonathan D. Lewis, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 10/384,575

(22) Filed: Mar. 11, 2003

(30) Foreign Application Priority Data
Mar. 12, 2002 (GB) 0205819.6

(51) Int. Cl. H04M 3/00

(52) U.S. Cl. 455/552.1; 455/418

(57) ABSTRACT

A signal processor for a multi-mode mobile communication device, comprising a multi-mode receiver adapted to receive information relating to a plurality of service modes; reconfigurable logic means, a configuration controller for configuring the reconfigurable logic means so as to support one or more of the service modes and a switching means for instructing the controller to alter the supported service mode in response to the received information.

### FIELD OF THE INVENTION

The present invention generally relates to signal processors, receivers, and receiving methods for digital mobile communications systems, especially third generation (3G) mobile communications systems. More particularly the invention relates to apparatus and methods for the controlling the operation of multiple service modes.

### BACKGROUND OF THE INVENTION

Third generation mobile phone networks use CDMA (Code Division Multiple Access) spread spectrum signals for communicating across the radio interface between a mobile station and a base station. These 3G networks, (and also so-called 2.5G networks), are encompassed by the International Mobile Telecommunications IMT-2000 standard (www.itu.int, hereby incorporated by reference). Third generation technology uses CDMA (Code Division Multiple Access) and the IMT-2000 standard contemplates three main modes of operation, W-CDMA (Wide band CDMA) direct spread FDD (Frequency Division Duplex) in Europe and Japan, CDMA-2000 multicarrier FDD for the USA, and TD-CDMA (Time Division Duplex CDMA) and TD-SCDMA (Time Division Synchronous CDMA) for China.

Collectively the radio access portion of a 3G network is referred to as UTRAN (Universal Terrestrial Radio Access Network) and a network comprising UTRAN access networks is known as a UMTS (Universal Mobile Telecommunications System) network. The UMTS system is the subject of standards produced by the Third Generation Partnership Project (3GPP, 3GPP2), technical specifications for which can be found at www.3gpp.org. These standards include Technical Specifications 23.101, which describes a general UMTS architecture, and 25.101 which describes user and radio transmission and reception (FDD) versions 4.0.0 and 3.2.2 respectively of which are hereby incorporated by reference.

FIG. 1 shows a generic structure of a third generation digital mobile phone system at 10. In FIG. 1 a radio mast 12 is coupled to a base station 14 which in turn is controlled by a base station controller 16. A mobile communications device 18 is shown in two-way communication with base station 14 across a radio or air interface 20, known as a Um interface in GSM (Global Systems for Mobile Communications) networks and GPRS (General Packet Radio Service) networks and a Uu interface in CDMA2000 and W-CDMA networks. Typically at any one time a plurality of mobile devices 18 are attached to a given base station, which includes a plurality of radio transceivers to serve these devices.

Base station controller 16 is coupled, together with a plurality of other base station controllers (not shown) to a mobile switching centre (MSC) 22. A plurality of such MSCs are in turn coupled to a gateway MSC (GMSC) 24 which connects the mobile phone network to the public switched telephone network (PSTN) 26. A home location register (HLR) 28 and a visitor location register (VLR) 30 manage call routing and roaming and other systems (not shown) manage authentication, billing. An operation and maintenance centre (OMC) 29 collects the statistics from network infrastructure elements such as base stations and switches to provide network operators with a high level view of the network's performance. The OMC can be used, for example, to determine how much of the available capacity of the network or parts of the network is being used at different times of day.

The above described network infrastructure essentially manages circuit switched voice connections between a mobile communications device 18 and other mobile devices and/or PSTN 26. So-called 2.5G networks such as GPRS, and 3G networks, add packet data services to the circuit switched voice services. In broad terms a packet control unit (PCU) 32 is added to the base station controller 16 and this is connected to a packet data network such as Internet 38 by means of a hierarchical series of switches. In a GSM-based network these comprise a serving GPRS support node (SGSN) 34 and a gateway GPRS support node (GGSM) 36. It will be appreciated that both in the system of

FIG. 1 and in the system described later the functionalities of elements within the network may reside on a single physical node or on separate physical nodes of the system.

Communications between the mobile device 18 and the network infrastructure generally include both data and control signals. The data may comprise digitally encoded voice data or a data modem may be employed to transparently communicate data to and from the mobile device. In a GSM-type network, text and other low-bandwidth data may also be sent using the GSM Short Message Service (SMS).

In a 2.5G or 3G network mobile device 18 may provide more than a simple voice connection to another phone. For example mobile device 18 may additionally or alternatively provide access to video and/or multimedia data services, web browsing, e-mail and other data services. Logically mobile device 18 may be considered to comprise a mobile terminal (incorporating a subscriber identity module (SIM) card) with a serial connection to terminal equipment such as a data processor or personal computer. Generally once the mobile device has attached to the network it is “always on” and user data can be transferred transparently between the device and an external data network, for example by means of standard AT commands at the mobile terminal-terminal equipment interface. Where a conventional mobile phone is employed for mobile device 18 a terminal adapter, such as a GSM data card, may be needed.

In a CDMA spread spectrum communication system a baseband signal is spread by mixing it with a pseudorandom spreading sequence of a much higher bit rate (referred to as the chip rate) before modulating the RF carrier. At the receiver the baseband signal is recovered by feeding the received signal and the pseudorandom spreading sequence into a correlator and allowing one to slip past the other until a lock is obtained. Once code lock has been obtained, it is maintained by means of a code tracking loop such as an early-late tracking loop which detects when the input signal is early or late with respect to the spreading sequence and compensates for the change. Alternatively a matched filter may be employed for despreading and synchronisation.

Such a system is described as code division multiplexed, as the baseband signal can only be recovered if the initial pseudorandom spreading sequence is known. A spread spectrum communication system allows many transmitters with different spreading sequences all to use the same part of the RF spectrum, with a receiver “tuning” to the desired signal by selecting the appropriate spreading sequence.

FIGS. 2a and 2b show, respectively, an exemplary front end 200 and a decoder 250 for a typical spread spectrum receiver. A receiver antenna 202 is connected to an input amplifier 204, which has a second input from an IF oscillator 208 to mix the input of RF signal down to IF. The output of mixer 206 is fed to an IF band pass filter 210 and thence to an AGC (Automatic Gain Control) stage 212. The output of AGC stage 212 provides an input to two mixers 252, 254 to be mixed with quadrature signals from an oscillator 258 and a splitter 256. This generates quadrature I and Q signals 260, 262 which are digitised by analogue to digital converters 264, which also output a control signal on line 266 to control AGC stage 212 to optimise signal quantisation.

Digitised I and Q signals 268, 270 from ADCs 264 are fed to Nyquist filters 272, 274 and thence to matched filters 276, 278, which are configured to provide a maximum output when a signal with the desired pseudorandom spreading sequence is received. The matched filter outputs feed bit synchronisation circuitry 280 which provides an error signal 286 to a delay locked loop 288 which generates sample clocks 290 to ADCs 264. Circuitry 280 also provides a second output 282 to a demodulator 284 for demodulating received data. Typically, as shown in FIG. 2, the RF signal is digitised at IF although it may be digitised at other points, for example after input amplifier 204.

In a 3G mobile phone system the baseband data is spread using a spreading or channelisation code using an Orthogonal Variable Spreading Factor (OVSF) technique. The OVSF codes allow the spreading factor to be changed whilst maintaining orthogonality between codes of different lengths. To increase the number of simultaneous users of the system the data is further spread by a scrambling code such as a Gold code. The scrambling code does not change the signal bandwidth but allows signals to or from different users to be distinguished from one another, again, because the spreading codes are substantially mutually orthogonal. The scrambling is used on top of the channelisation spreading, that is a signal at the chip rate following OVSF spreading is multiplied by the scrambling code to produce a scrambled code at the same chip rate. The chip rate is thus determined by the channelisation code and, in this system, is unaffected by the subsequent scrambling. Thus the symbol rate for a given chip rate is likewise unaffected by the scrambling.

Different spreading factors and scrambling code links are generally employed for the down link from the base station to the mobile station and for the up link from the mobile station to the base station. Typically the channelisation codes have a length of between 4 chips and 256 chips or, equivalently, a spreading factor of between 4 and 256 (although other spreading factors may be employed). The up link and down link radio (data channel) frames generally last 10 ms, corresponding to a scrambling code length of 38400 chips although shorter frames, for example of 256 chips, are sometimes employed on the up link. A typical chip rate is 3.84 M chips/sec (Mcps), which determines the maximum bit rate for a channel—for example with a spreading factor of 16, that is 16 chips per symbol, this gives a data rate of 240 Kbps. It will be recognised that the foregoing figures are provided merely for the purposes of illustration. Where higher bit rate communications with a mobile station are required more than one such channel may be employed to create a so-called multicode transmission. In a multicode transmission a plurality of data channels are used, effectively in parallel, to increase the overall rate of data transmission to or from a mobile station. Generally the multicode data channels have the same scrambling code but different channelisation codes, albeit preferably with the same spreading factor.

In a 3G mobile phone system there are generally a number of different channels; some dedicated to particular users and some common to groups of users such as all the users within a given cell or sector. Traffic is carried on a Dedicated Physical Control Channel (DPCH), or on a plurality of such channels in the case of a multicode transmission, as described above. The common channels generally transport signalling and control information and may also be utilised for the physical layer of the system's radio link. Thus a Common Pilot Channel (CPICH) is provided comprising an unmodulated code channel scrambled with a cell-specific scrambling code to allow channel estimation and equalisation at the mobile station receiver. Similarly a Synchronisation Channel (SCH) is provided for use by the mobile station to locate network cells. A primary SCH channel is unmodulated and is transmitted using the same channelisation spreading sequence in each cell and does not employ a cell-specific scrambling code. A similar secondary SCH channel is also provided, but with a limited number of spreading sequences. Primary and Secondary Common Control Physical Channel (PCCPCH, SCCPCH) having known channelisation and spreading codes are also provided to carry control information. The foregoing signalling channels (CPICH, SCH and CCPCH) must generally be decoded by all the mobile stations and thus the spreading codes (channelisation codes and where appropriate, scrambling code) will generally be known by the mobile station, for example because the known codes for a network have been stored in the user-end equipment. Here the references to channels are generally references to physical channels and one or more network transport channels may be mapped to such a physical channel. In the context of 3G mobile phone networks the mobile station or mobile device is often referred to as a terminal and in this specification no distinction is drawn between these general terms.

One advantage of spread spectrum systems is that they are relatively insensitive to multipath fading. Multipath fading arises when a signal from a transmitter to a receiver takes two or more different paths and hence two or more versions of the signals arrive at the receiver at different times and interfere with one another. This typically produces a comb-like frequency response and, when a wide band signal is received over a multipath channel, the multiple delays give the multiple components of the received signal the appearance of tines of a rake. The number and position of multipath channels generally changes over time, particularly when the transmitter or receiver is moving. As the skilled person will understand, a correlator in a spread spectrum receiver will tend to lock onto one of the multipath components, normally the direct signal which is the strongest. However a plurality of correlators may be provided to allow the spread spectrum receiver to lock onto a corresponding plurality of separate multipath components of the received signal. Such a spread spectrum receiver is known as a rake receiver and the elements of the receiver comprising the correlators are often referred to as “fingers” of the rake receiver. The separate outputs from each finger of the rake receiver are combined to provide an improved signal to noise ratio (or bit error rate) generally either by weighting each output equally or by estimating weights which maximise the signal to noise ratio of the combined output. This latter technique is known as Maximal Ratio Combining (MRC).

FIG. 3 shows the main components of a typical rake receiver 300. A bank of correlators 302 comprises, in this example, three correlators 302a, 302b and 302c each of which receives a CDMA signal from input 304. The correlators are known as the fingers of the rake; in the illustrated example the rake has three fingers. The CDMA signal may be at baseband or at IF (Intermediate Frequency). Each correlator locks on to a separate multipath component which is delayed by at least one chip with respect to the other multipath components. More or fewer correlators can be provided according to a quality-cost/complexity trade off. The outputs of all the correlators go to a combiner 306 such as an MRC combiner, which adds the outputs in a weighted sum, generally giving greater weight to the stronger signals. The weighting may be determined based upon signal strength before or after correlation, according to conventional algorithms. The combined signal is then fed to a discriminator 308 which makes a decision as to whether a bit is a 1 or a 0 and provides a baseband output. The discriminator may include additional filtering, integration or other processing. The rake receiver 300 may be implemented in either hardware or software or a mixture of both.

Referring now to FIG. 4, this shows in more detail an example of W-CDMA rake receiver 400 according to the prior art. The receiver 400 has an antenna 402 to receive the spread spectrum signal for the DPCH (Dedicated Physical Data Channel), PCCPCH, and CPICH channels. The signal received by antenna 402 is input to a down converter 404 which down converts the signal to either IF (Intermediate Frequency) or base band for despreading. Typically at this point, the signal will be digitised by an analogue-to-digital converter for processing in the digital domain by either dedicated or programmable digital signal processors. To preserve both magnitude and phase information the signal normally comprises I and Q channels although for simplicity these are not shown in FIG. 4. In this receiver, and generally in the receivers described below, the signal processing in either the analogue or the digital domain or in both domains may be employed. However, since normally much of the processing is carried out digitally, the functional element drawn as blocks in FIG. 4 will generally be implemented by appropriate software or, where specialised integrated circuits are available for some of the functions, by appropriately programming registers in these integrated circuits to configure their architecture and/or functionality for performing the required functions.

Referring again to FIG. 4, the receiver 400 comprises 3 rake fingers 406, 408 and 410 each having an output to rake combiner 412, which provides a combined demodulated signal output 414 for further processing in the mobile terminal. The main elements of each rake finger correspond and, for simplicity, only the elements of rake finger 406 are shown.

A code tracker 416 is coupled to the input of rake finger 406 to track the spread spectrum codes for despreading. Conventional means such as a matched filter or an early-late tracking loop may be employed for code tracker 416 and since the DPCH, PCCPCH and CPICH channels are generally synchronised the code tracker 416 need only lock on to one of these signals but normally CPICH because this generally has a relatively high signal level. The output of the code tracker 416 controls code generators for PCCPCH 418, CPICH 420, and DPCH 422 which generate spreading codes for cross-correlation with their corresponding channel signals to despread the spread spectrum signals. Thus three despreaders 424, 426, 428 are provided, each coupled to the rake finger input, and each receiving an output from one of the code generators 418, 420, 422 to despread the appropriate signal (both channelisation and scrambling codes). As the skilled person would appreciate these despreaders will generally comprise a cross-correlator such as a multiplier and summer.

The CPICH pilot signal is unmodulated so that when it is despread the result is a signal with a magnitude and phase corresponding to the attenuation and phase shift of the multipath channel through which the CPICH signal locked onto by the finger of the rake receiver has been transmitted. This signal thus comprises a channel estimate for the CPICH channel, in particular for the multipath component of this channel the rake finger has despread. The estimate may be used without further processing but, preferably the estimate is averaged over time, over one or more symbol intervals, to reduce noise on the estimate and increase its accuracy. This function is performed by channel estimate 430. It will be appreciated although averaging over a long period will reduce the level of noise, this will also reduce the ability of the receiver to respond quickly to changing channel conditions such as are encountered when, for example, the receiver is operating in a terminal in a car on a motorway.

The channel estimate is conjugated to invert the phase and if necessary normalised so that zero attenuation corresponds to a magnitude of unity, and in this form the conjugated signal can simply be used to multiply another received signal to apply or compensate for the channel estimate. Thus multipliers 432 and 434 apply the channel estimate from channel estimate block 430 to the broadcast control channel PCCPCH and to the desired data channel DPCH respectively. The desired data channels are then combined by rake combiner 412 in any conventional fashion and the broadcast channel outputs from each finger, such as broadcast channel output 436 from rake finger 406, are also combined in a second rake combiner (not shown in FIG. 4) to output a demodulated PCCPCH control channel signal.

It is desirable to be able to provide mobile communications terminals, and in some instances base stations, capable of receiving both 3G mobile phone signals and legacy 2G (and 2.5G) signals. This provides flexibility for network operators, coverage where 3G signals are not available, and simplifies the upgrading of existing networks to 3G. Such terminals also help reduce the pressure on bandwidth because 2G communication network protocols may be employed where large bandwidths are not required.

A multi-mode terminal typically supports a 3G mode such as W-CDMA, and GSM, although other 2G technologies such as IS (Interim Standard)-95 may also be supported. Typically such terminals can only operate in one mode at the one time and change mode manually or automatically. Automatic switching between modes can occur when coverage for the other is lost or if continuous scanning identifies a preferred coverage for the other mode.

In this regard, software radio technology is a developing technology that is changing the way wireless systems are designed. Software radios define their functionality through software rather than hardware, which allows upgrades to be readily provided and also permits the radio to switch between protocols relatively rapidly. In such systems, however, it is difficult to switch all logic from supporting one mode to another because of the requirement for alternative mode monitoring. For example, a terminal in W-CDMA mode should also support monitoring of GSM frequencies. This monitoring could be limited to only received signal strength indication (RSSI) measurements, but for a more effective implementation would provide other typical GSM receiver functionality, such as equalisation in order to minimise signal distortion and interference. For a software implementation to achieve this functionality, costly software would be required, and the system would also be likely to consume significant amounts of power. There therefore remains a need for reduced power consumption, and, preferably, reduced cost.

### SUMMARY OF THE INVENTION

According to the present invention there is therefore provided a signal processor for a multi-mode mobile communication device, comprising: a multi-mode receiver adapted to receive information relating to a plurality of service modes; reconfigurable logic means; a configuration controller for configuring the reconfigurable logic means so as to support one or more of the service modes; and a switching means for instructing the controller to alter the supported service mode in response to the received information.

The invention also provides a related method of controlling a signal processor in a mobile communication device, comprising the steps of: receiving information indicative of a first service mode to be supported by the communication device; and configuring a reconfigurable logic means so as to support the first service mode

Preferably, the inventive method further comprises configuring a portion of the reconfigurable logic means so as to provide partial support for a second service mode.

Hence, while in a given service mode, such as W-CDMA, reconfigurable logic may be configured to give complete support for the main mode and partial support for an alternative mode. Preferably the partial support is just enough to perform monitoring. The use of reconfigurable logic enables more radio systems to be supported, as compared with the use of a static ASIC design.

The signal processor may be employed in a mobile terminal, such as a multimode mobile phone handset, or in a base station.

In a related aspect the invention also provides method of testing a service mode on a communication device including a reconfigurable logic means, the method comprising the steps of: receiving the service mode configuration to be tested over an air interface; and configuring the reconfigurable logic means with the received service mode configuration.

In a still further related aspect, the present invention provides a method of establishing communication with a multi-mode mobile communication terminal supporting a first operating mode including the steps of: establishing a communication link via the first operating mode that is adapted to be in communicable relation with one or more alternative network providers.

The invention also provides code and a carrier medium carrying processor control code to implement the above described signal processing arrangements and methods. This processor control code may comprise computer program code, for example to control a digital signal processor, or other code such as a plurality of register values to set up a general purpose receiver integrated circuit to implement the above signal processing. The carrier may comprise a data carrier or storage medium such as a hard or floppy disk, CD- or DVD-ROM, or a programmed memory such as a read-only memory, or an optical or electrical signal carrier. As the skilled person will appreciate the control code may be also be distributed between a plurality of coupled components, for example over a network.

### BRIEF DESCRIPTION OF THE DRAWINGS

These and other aspects of the invention will now be further described, by way of example only, with reference to the accompanying figures in which:

FIG. 1 shows the structure of a generic 3G mobile phone system;

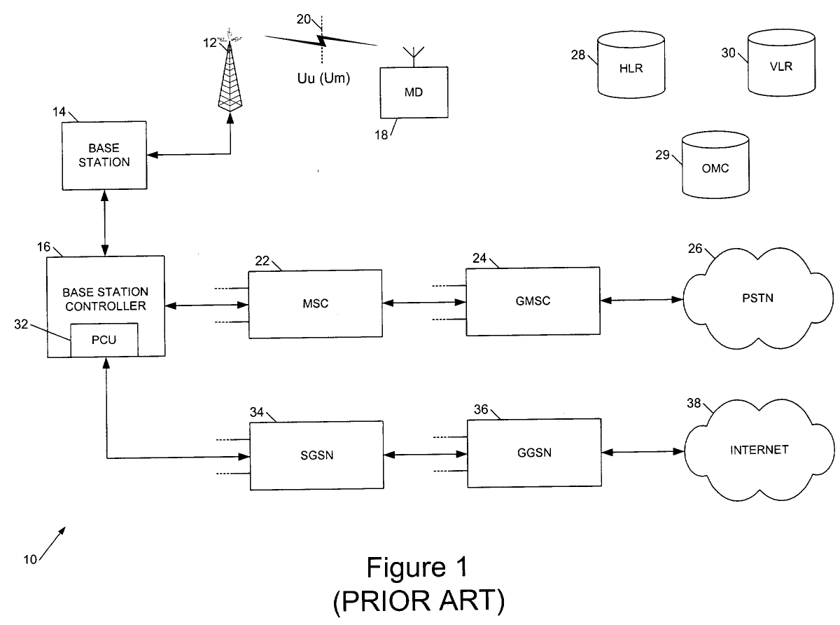

FIGS. 2a and 2b show, respectively, an example of a front end for a spread spectrum receiver, and a spread spectrum decoder according to the prior art;

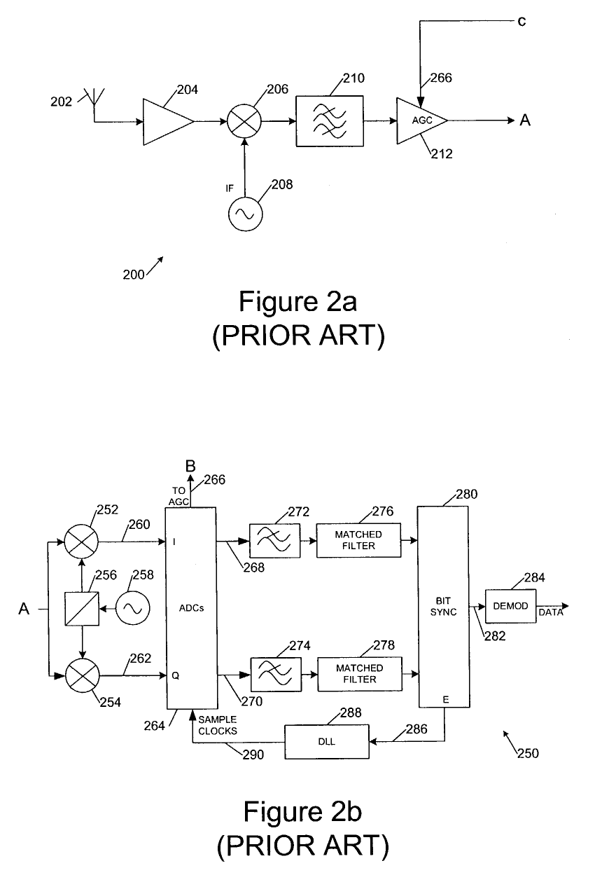

FIG. 3 shows the main elements of a spread spectrum rake receiver;

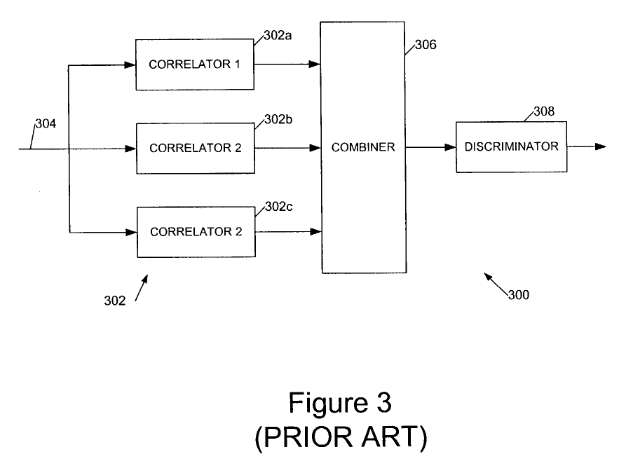

FIG. 4 shows an exemplary W-CDMA rake receiver for a digital mobile phone network; and

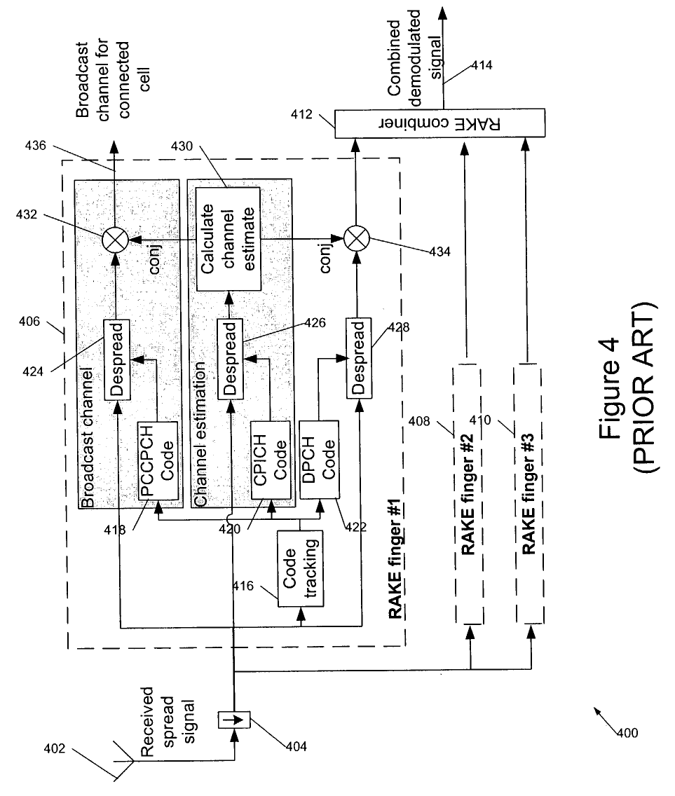

FIG. 5 shows a multi-mode signal processor in accordance with an embodiment of the present invention.

### DETAILED DESCRIPTION

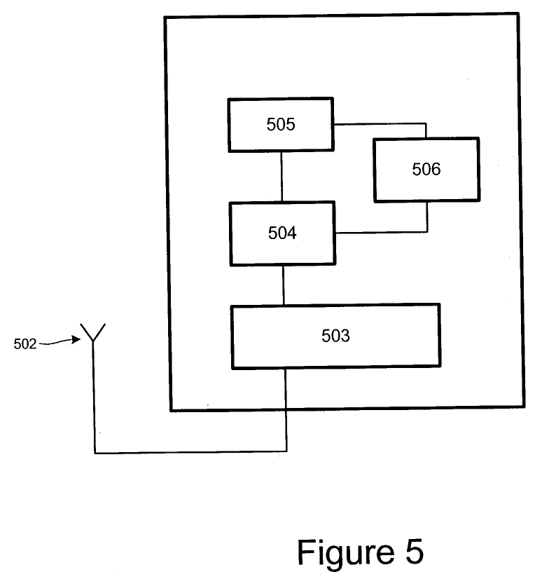

Referring now to FIG. 5, this shows a schematic block diagram of one embodiment of a signal processor 500 for the front end of a multi-mode receiver of a wireless terminal or base station.

An antenna 502 provides a signal to an RF unit 503. The RF unit 503 typically includes analogue-to-digital converters (not shown) which provide a digitised output to a decoder/demodulator 504. According to the invention, this decoder/demodulator 504 is implemented using reconfigurable logic, such as using field programmable gate arrays (FPGAs). This configuration of the decoder/demodulator is determined by the processor 505, which monitors various criteria to reach a suitable determination. That is, the processor 505 loads appropriate configurations into the logic 504 depending upon a given set of criteria such as available logic resources, energy status of the device (i.e. required power consumption), geographic location etc.

When an alternative mode is required, such as at system handover time or as a result of other external events, the processor will reconfigure the reconfigurable logic at 504 so as to be able to operate in the alternative mode, such as GSM or CDMA2000. In this way, the structure of the mobile device is simplified and reduced in size, as dedicated hardware is not required for the plurality of different modes: a single set of reconfigurable logic is utilised for all modes.

It will be appreciated that full support for a particular alternative radio standard may never be required, so the mobile device embodying the present invention has the flexibility to cater for full support, should it be required, and also still enjoy the advantage of the reduction in silicon size.

While typically a multi-mode signal processor would support two modes, such as W-CDMA and GSM, or alternatively W-CDMA and CDMA2000, it is within the scope of the present invention to support additional and/or alternative modes. For each mode that is supported, the signal processor, in one embodiment of the invention, will provide a pair of configurations programmable in the reconfigurable logic: one for full support and the other for partial support, such as monitoring only. These configurations are loaded into the reconfigurable logic as required. The monitoring configuration has a reduced functionality when compared with the full support configuration as high quality filtering is not required and hence requires less processing capacity of the reconfigurable array. Therefore, by partitioning the functionality of a radio system into a monitoring part and a main operating part, it is possible to achieve lower power consumption. Also, the partitioning reduces the amount of reconfigurable logic, which reduces the cost of the signal processing system.

If the reconfigurable logic is configured to perform monitoring for a particular mode at the same time as providing full support for a main mode, and the main mode subsequently required additional resources to perform its operations, it is preferable that the main operating mode is given priority. Therefore, the reconfigurable logic should only support additional modes, such as performing monitoring, when it is able to do so without affecting the main mode operation. In this embodiment, on handover from one mode to another, a new configuration would be instantiated in the reconfigurable logic, which could provide full support for a new mode, such as GSM, and partial support for the previous mode (W-CDMA) or another mode to be monitored.

It is to be appreciated that the expression full support is to be understood as meaning that the mode is provided with all the resources necessary and available to the communication device in order for the mode to have full functionality. This may or may not require configuration of the all the resources of the reconfigurable logic device. For example, where the reconfigurable logic device is a FPGA, a number of rows may remain unused even when full functionality is provided to the operating mode. When this occurs, it is possible to allocate the remaining resources of the reconfigurable device to one or more alternative modes. Due to silicon size constraints, it is to be expected that any remaining resources would only be able to provide partial support to the alternative modes. In this regard, partial support is not full support, in that only limited functionality is provided to the alternative modes, such as only monitoring functionality.

In a still further alternative mode of operation, partial support may be given to one or more additional modes on a periodic basis. For example, if the main mode being supported is W-CDMA, periodically some of the reconfigurable logic resources may be reconfigured to various tasks, such as to support monitoring. This may be achieved at the expense of reducing the performance of the main operating functions, such as by reducing the number of rake fingers.

In an alternative embodiment of the invention, the signal processor is also provided with a caching mechanism 506. This caching mechanism 506 could be used to ensure that the configurations that are likely to be used are quickly loaded when available. This embodiment of the invention is particularly advantageous if the terminal frequently switches from one mode to another, as the reconfigurable logic would also be continually switching between configurations. Further, if the processing system had to remove some configuration data for a particular system, such as monitoring data, it may keep the configuration in the caching mechanism, as it is likely to be the first function that will be required in advance of full support for an alternative mode.

If there are enough resources, such as when the signal processor is used in a base station, hysteresis could be used to ensure that a configuration is not discarded until a certain time limit, or other measured value, has been exceeded. This embodiment of the invention will aid in minimising reconfiguration times when constantly switching.

In another embodiment of the invention, which is particularly applicable when the signal processor is utilised in a mobile handset, if battery power is getting low, the processor 505 could switch to supporting just a single mode, such as GSM, which has a lower power requirement compared to W-CDMA.

In a still further embodiment of the invention, where the radio system in use supports software download, it is within the scope of the invention for configurations to be downloaded over the air interface, rather than retrieving the configurations from an internal memory storage area. This would assist in further reducing the size the silicon required for the signal processor. In practical terms, the system could download support for monitoring an alternative system at any time, in view of the generally manageable size of monitoring configurations. In terms of downloading configurations for full support, however, it would be preferable if the system only downloaded such configurations at appropriate times. For example, the controller 505 could monitor various criteria and only download a full configuration where handover looks viable based upon measurement reports.

In a related embodiment of the invention, the radio system could download configurations relating to a possible candidate modulation scheme in order to test whether the modulation scheme is appropriate for a given mobile terminal or base station. With this embodiment of the invention, a completely new modulation/radio propagation method could be tested before being instantiated in a mobile terminal/base station. For instance, this could be done to a number of terminals in a system to determine the optimum mix of modulation methods within a geographical area. The information downloaded could be a mixture of software and hardware configuration information. In this regard, if the terminal were completely software based, then the complexity of possible radio systems that could be executed would be limited.

Therefore, with this embodiment of the invention, it is apparent that through the use of reconfigurable logic in mobile handsets and base stations, it becomes possible to test and also upgrade the modes in which the handset/base station operates.

In another embodiment, the present invention extends to multi-mode systems even where the current serving network does not have support for interworking with an alternative network. For example, a terminal may have support for W-CDMA and CDMA-2000. The terminal may be on a CDMA2000 network but a local W-CDMA network may also be detected and be preferable to use due to some criterion, such as billing price or signal quality. Typically, if the current service network, in this case CDMA2000 did not have support for interworking with the W-CDMA network, then the terminal would have to break the link with the CDMA 2000 network before registering on the W-CDMA network. It is in the interests of the user to minimise the duration of this break as much as possible.

Therefore, in this embodiment of the invention, and continuing with this example, where the terminal is fully supporting CDMA-2000 and providing partial support to W-CDMA, the partial support can be configured to allow not only monitoring of W-CDMA, but also to undertake certain protocol messaging necessary before setting up a full W-CDMA connection. That is, the partial support may be utilised to send measurement or registration requests to the W-CDMA network in order to speed up registration time or discover if admission to the network would be permitted. Where these acts are performed before relinquishing the CDMA-2000 network, the original network, the time between breaking off the CDMA2000 link and establishing the W-CDMA link is reduced.

In a further alternative embodiment of the invention, where one network is fully supported by a mobile terminal and it is not possible for an alternative network to be partially supported in order to monitor measurement data, the present invention provides a mechanism for monitoring the alternative network whilst operating in a network that does not have support for interworking. In this regard, the configuration for the operating network is adapted to communicate with the alternative mode provider using a communication link such as an IP link. In other words, the terminal can communicate with an alternative service provider by establishing a data link over the existing link. Hence, the terminal is able to communicate with the alternative mode provider, although the communication is not direct. This indirect communication can be utilised for various purposes, such as to pass measurement data to the alternative network via the IP link established on the operating network or to establish a handover. Once again, this alternative embodiment of the invention may be utilised to speed up registration time or discover if admission to the alternative network would be permitted before relinquishing the original operating network.

This embodiment of the invention may be utilised in order to establish an Internet service. In this regard, an Internet site may be established which is able to communicate with the various alternative network providers and terminal users. Over an IP link, the site could negotiate for a terminal user the cheapest operating network available to the terminal user in the particular area. Further, the service may negotiate rates dynamically with the different service operators. These negotiations could be at least partly based upon the measurement report information communicated from the terminal over the IP link. Therefore, this embodiment of the invention is able to provide a mobile terminal with a degree of multi-system communication even when interworking is not supported by the current serving network.

This arrangement may be used in conjunction with the dual mode monitoring using reconfigurable logic as described above. However, the above described method can be used in a system which does not provide dual- or multi-mode operation using reconfigurable logic. In this way, a terminal can check for availability and whether service will be provided using a data link to the new service provider without breaking the connection to the current network.

It will be appreciated that the broad inventive concepts of the present invention may be applied to any communication networks, and that the embodiments shown are intended to be merely illustrative and not limiting. For example although the invention has been described with reference to digital mobile phone networks, the skilled person will also appreciate that it has applications in other radio systems, for example Hiperlan 2. Further, although the explicitly described embodiment processes W-CDMA and GSM signals, CDMA2000 is an alternative scheme, and the general principles are applicable to IS-95, digital AMPS, iDEN (Integrated Digital Enhanced Network), and, if desired, private mobile radio communications such as TETRA.

We claim:

1. A signal processor for a multi-mode mobile communication device, comprising:
a multi-mode receiver adapted to receive information relating to a plurality of service modes;
reconfigurable logic means;
a configuration controller for configuring the reconfigurable logic means so as to support one or more of the service modes; and
a switching means for instructing the controller to alter the supported service mode in response to the received information.

2. The signal processor of claim 1 wherein the reconfigurable logic is adapted to fully support a first service mode and partially support an alternative service mode.

3. The signal processor of claim 2 wherein the partial support provides communication with the alternative service mode in order to establish if admission to the alternative service mode is possible.

4. The signal processor claim 2 wherein the partial support provides communication with the alternative service mode in order to at least partially undertake protocol messaging for registration of the alternative service mode as the operating network.

5. The signal processor of claim 2 further comprising a priority controller for providing the fully supported service mode with priority over the partially supported service mode for the use of the reconfigurable logic means

6. The signal processor according to claim 1 wherein the configuration controller further comprises timing means for periodically configuring the reconfigurable logic means so as to partially support an alternative service mode.

7. The signal processor according to claim 1 wherein the received information relates to at least one of the following: system handover, available reconfigurable logic resources, energy status of the communication device and a geographical location of the communication device.

8. The signal processor according to claim 1 where the communication device is a mobile terminal, the signal processor further comprising a monitoring means for instructing the controller to switch to only a low power service mode upon determining that the battery power of the terminal is low.

9. The signal processor according to claim 1 further including a downloader for receiving service mode configurations over an air interface.

10. The signal processor according to claim 1 further including retrieval means for retrieving a service mode configuration from a memory within the communication device and providing the retrieved configuration to the configuration controller.

11. The signal processor according to claim 1 further comprising a cache for storing a previously used configuration for possible reuse by the reconfigurable logic means.

12. The signal processor of claim 11 wherein the cache uses hysteresis.

13. The signal processor according to claim 1 wherein the plurality of services modes include W-CDMA and GSM.

14. The signal processor according to claim 1 wherein the plurality of services modes include W-CDMA and CDMA2000.

15. A method of controlling a signal processor in a mobile communication device, comprising:
receiving information indicative of a first service mode to be supported by the communication device; and
configuring a reconfigurable logic means so as to support the first service mode.

16. The method of claim 15 further comprising the step of configuring a portion of the reconfigurable logic means so as to provide partial support for a second service mode.

17. The method of claim 16 wherein the partial support is monitoring support.

18. The method of claim 16 wherein the partial support provides communication with the second service mode in order to establish if admission to the second service mode is possible.

19. The method of claim 16 wherein the partial support provides communication with the second service mode in order to at least partially undertake protocol messaging for registration of the second service mode as the operating network.

20. The method according to claim 15 further comprising the steps of:
receiving information indicative of an alternative service mode to be fully supported by the communication device; and
reconfiguring the reconfigurable logic means so as to provide full support for the alternative service mode.

21. The method according to claim 17 further comprising the step of storing the first service mode full support configuration in a cache for possible reuse.

22. The method of claim 20 further comprising the step of configuring a portion of the reconfigurable logic means so as to provide partial support for the first service mode.

23. The method according to claim 16 further comprising the step of providing the fully supported service mode with priority over the partially supported service mode for the use of the reconfigurable logic means.

24. The method according to claim 16 wherein the partial support is provided periodically.

25. The method according to claim 15 wherein the information received relates to at least one of the following: system handover, available reconfigurable logic resources, energy status of the communication device and a geographical location of the communication device.

26. The method according to claim 15 further comprising the step of providing support for only a low power service mode where the communication device is a mobile terminal and the information received indicates that battery power of the terminal is low.

27. The method according to claim 15 wherein service mode configurations are retrieved from a memory within the communication device.

28. The method according to claim 15 wherein service mode configurations are downloaded to the communication device over an air interface.

29. The method according to claim 15 wherein the first service mode is W-CDMA and the second service mode is GSM.

30. The method according to claim 15 wherein the first service mode is W-CDMA and the second service mode is CDMA2000.

31. A method of testing a service mode on a communication device including a reconfigurable logic means, the method comprising the steps of:
receiving the service mode configuration to be tested over an air interface; and
configuring the reconfigurable logic means with the received service mode configuration.

32. A method of establishing communication with a multi-mode mobile communication terminal supporting a first operating mode including the steps of:
establishing a communication link via the first operating mode that is adapted to be in communicable relation with one or more alternative network providers.

33. The method of claim 32 wherein the communication link is an IP link.

34. The method of claim 32 wherein the communication link is utilised to pass measurement data to an alternative network provider.

35. The method of claim 32 wherein the communication link is utilised to at least partially establish handover with an alternative network provider.

36. The method according to claim 32 wherein the communication link is utilised to establish an online service providing communication between the terminal and one or more alternative network providers.

37. The method according to claim 36 wherein the communication link is utilised to determine the most cost effective network to operate.

38. The method according to claim 36 wherein the communication link is utilised to negotiate with the one or more alternative network providers.

39. A mobile communication terminal comprising a signal processor, the terminal comprising:
a multi-mode receiver adapted to receive information relating to a plurality of service modes;
reconfigurable logic means;
a configuration controller for configuring the reconfigurable logic means so as to support one or more of the service modes; and
a switching means for instructing the controller to alter the supported service mode in response to the received information.

40. A mobile communication base station comprising a signal processor for multi-mode mobile communication, the base station comprising:
a multi-mode receiver adapted to receive information relating to a plurality of service modes;
reconfigurable logic means;
a configuration controller for configuring the reconfigurable logic means so as to support one or more of the service modes; and
a switching means for instructing the controller to alter the supported service mode in response to the received information.
